(19) United States
(12) Patent Application Publication
(10) Pub. No.: US 2007/0266954 A1
(43) Pub. Date: Nov. 22, 2007

(54) Kelp klip

(76) Inventor: James Harold Chapman III, Long Beach, CA (US)

Correspondence Address: JAMES HAROLD CHAPMAN III, 3521 EAST 1ST STREET, APE. B, LONGBEACH, CA, 90803, US

(21) Appl. No.: 11/288,048

(22) Filed: May 20, 2006

(51) Int. Cl. A01K 63/00

(52) U.S. Cl. 119/253

(57) ABSTRACT

This invention (The Kelp Klip) provides a natural looking, less time consuming way to feed marine fish and other herbivorous animals as well as fresh water fishes. Instead of attaching to the side of the aquarium glass of acrylic, it is a hands-free way of feeding. It resembles a real marine algae that will not reveal the feeding of fish and other animals. This invention will give a more natural appearance than other aquatic feeding devices. This invention can be adjusted to be used in virtually any depth in an aquarium by adding additional extensions. This invention will also eliminate the hurdle of getting hands and arms wet when placing into and retrieving from an aquarium. They way in which the seaweed is held by the Kelp Klip will minimize the amount of seaweed lost to filters and will reduce fouling of the water in an aquarium.

This product provides a more realistic approach to feeding seaweed to herbivorous and omnivorous fish and other aquarium animals without getting hands and arms wet. This product resembles real kelp/algae (various species) consisting of a substrate rock, a holdfast, a stipe and veins that will hold the pieces of seaweed (algae) that will resemble the blades of a natural kelp plant.

Substrate Rock:

The substrate rock will mimic the texture and coloration of an actual rock. The weight of this rock would be enough to keep the feeding device from being moved when fish are feeding. This rock will also contain a magnet that will allow for easy retrieval from the bottom of the aquarium. On the outside of the rock there will be a small peg that can resemble a sponge or other small animal that might feed on the holdfast that can be grasped with a grip and lowered back into the aquarium to the desired location. This rock will also have an artificial holdfast imprinted on the rock. At the top of the rock there will be a cavity with a peg in the middle that will allow for the removal and reattachment of the stipe for cleaning purposes. This internal peg also allows for the natural movement of the stipe and pieces of seaweed that will stimulate feeding. The stipe does not attach tightly to the peg, but allows room for movement.

This product provides a more realistic approach to feeding seaweed to herbivorous and omnivorous fish and other aquarium animals without getting hands and arms wet. This product resembles real kelp/algae (various species) consisting of a substrate rock, a holdfast, a stipe and veins that will hold the pieces of seaweed (algae) that will resemble the blades of a natural kelp plant.

Substrate Rock:

The substrate rock will mimic the texture and coloration of an actual rock. The weight of this rock would be enough to keep the feeding device from being moved when fish are feeding. This rock will also contain a magnet that will allow for easy retrieval from the bottom of the aquarium. On the outside of the rock there will be a small peg that can resemble a sponge or other small animal that might feed on the holdfast that can be grasped with a grip and lowered back into the aquarium to the desired location. This rock will also have an artificial holdfast imprinted on the rock. At the top of the rock there will be a cavity with a peg in the middle that will allow for the removal and reattachment of the stipe for cleaning purposes. This internal peg also allows for the natural movement of the stipe and pieces of seaweed that will stimulate feeding. The stipe does not attach tightly to the peg, but allows room for movement.

Stipe:

The stipe will resemble an actual stipe of a kelp (algal) plant. The material will be made of a type of rubber/resin that is now manufactured for aquarium exhibits. The diameter and height of the stipe can be varied, depending on the depth of the aquarium and the amount of feeding that will take place. At the top of the stipe there will be several fronds/branches (depending on need) extending from the stipe that will be the location where the seaweed (algae) pieces will be attached. At the base of each frond there will be a float to thoroughly replicate the seaweed's structure. The attachment section will be comprised of several long clips that are slender, the desired color and inside the branches. The clips will resemble the veins of the kelp blades.

Retrieval and Placement within Aquarium:

The process by which the Kelp Klip will be removed and placed back into the aquarium is by utilizing magnets and a grasping device located at the end of a pole with a handle and a trigger that can be adjusted to fit any average depth of aquarium.

The pole will have the magnet at the end with the grip behind it. The magnet can be used to remove the Kelp Klip from the aquarium and the grip can be used to hold the Kelp Klip before lowering into the aquarium and be easily placed where desired. The grip can also be used to move various items around in the aquarium without getting hands/arms wet. The grip can be used to target feed other invertebrates in the aquarium such as sea anemones and small animals within rock crevasses.

Other Attributes:

The stipe can be changed to other species and colors, (green, red, brown) by removing from peg and replacing with newly desired stipe.

Not as unsightly as other clips that have to be attached to the glass/acrylic of the aquarium. Prevents unnecessary scratches to glass and acrylic aquariums. Looks completely natural in an aquarium environment. Salt-water aquarium environments are somewhat expensive. The tropical fish are also somewhat expensive. This product will compliment and add integrity to these environments.

Process of Making the Kelp Klip:

1) The Kelp Klip can be constructed of a resin or plastic material that is currently used to make artificial aquarium plants. The portion of the product that will resemble a rock can be made of a higher-weight resin or plastic, to keep it from being moved by water currents. The magnet that will be used to retrieve the Kelp Klip will be inserted into the plastic or resin that will form the rock structure before it settles, allowing the magnet to be located within the rock without being seen. On the outside of the rock structure, a prong will be molded to allow for the Kelp Klip to be placed within aquaria by the pole that will also be made of a plastic and have a magnet and a grasping device on the end. The feeding devices can also be made of a plastic or resin and molded into the desired shapes. Within these branches of the Kelp Klip (pieces of plastic or resin), the clips (two prongs with a spring at the bottom) will be inserted into the plastic or resin before it has settled. The prongs will also be coated with a protective plastic before insertion into the feeding device (Stipes). The connectors between each stipe and also between the lowest stipe and the rock can be made by creating the appropriate indention that would allow for attachment by the stipes. Each stipe will also have a plug molded at the base that will snap into each indention (hole).

The Kelp Klip is a product that is designed to make the feeding all types of herbivorous and omnivorous fish much easier. The Kelp Klip is made of durable plastics that begin with a base designed as a rock with artificial sponges and corals molded for added beauty and authenticity. This rock will be of a moderate weight so it will not float or be moved with water currents. Inside this artificial rock is a magnet that will make removal from an aquarium easier and prevents arms and hands from getting wet. At the top of this rock will be a prong by which you can attach the thallus for feeding.

The thallus of the Kelp Klip will also be made of a durable plastic that will move a little with water current. The will give a realistic feel to the product. The thallus will be separate from the rock and will consist of a small opening by which you can attach it to the rock. Extending from the thallus is a small bladder that will contain the mechanism with which seaweed can be attached for feeding.

This mechanism consists of a hinged device similar to a hair clip. This device will be inside of the bladder, separate from the water and not visible. Extending outward is a pair of thin arms made of a durable plastic that can be opened and then closed on the seaweed to be fed resembling the vein of a kelp blade.

Above each intersection of the two stipes there will be a prong that will allow for the attachment of additional clips. The additional clips will have an opening at the bottom of the thallus that will attach to the prong of the clip below it.

The Kelp Klip will be made to imitate a variety of marine/and fresh water algae. This will be accomplished by varying size, shape and color to give users a choice of what type of seaweed they would like to have replicated in their aquarium. In addition to keeping users from getting wet, the Kelp Klip will also prevent excess seaweed from being wasted by attaching to the very middle of the piece of seaweed being fed. This will allow more surface area of the piece of seaweed to be eaten, and less will float away.

An pole with a trigger mechanism will have a dual action tip. On one side of the tip will be a magnet that will be used for retrieval from the aquarium On the opposite side of this tip will be a clamping device that is connected to the trigger mentioned before. This pole is extendable from the middle area which will allow for easy placement and removal of the Kelp Klip from anywhere in the aquarium.

This product provides a more realistic approach to feeding seaweed to herbivorous and omnivorous fish and other aquarium animals without getting hands and arms wet. This product resembles real kelp/algae (various species) consisting of a substrate rock, a holdfast, a stipe and veins that will hold the pieces of seaweed (algae) that will resemble the blades of a natural kelp plant.

Substrate Rock:

The substrate rock will mimic the texture and coloration of an actual rock. The weight of this rock would be enough to keep the feeding device from being moved when fish are feeding. This rock will also contain a magnet that will allow for easy retrieval from the bottom of the aquarium. On the outside of the rock there will be a small peg that can resemble a sponge or other small animal that might feed on the holdfast that can be grasped with a grip and lowered back into the aquarium to the desired location. This rock will also have an artificial holdfast imprinted on the rock. At the top of the rock there will be a cavity with a peg in the middle that will allow for the removal and reattachment of the stipe for cleaning purposes. This internal peg also allows for the natural movement of the stipe and pieces of seaweed that will stimulate feeding. The stipe does not attach tightly to the peg, but allows room for movement.

Stipe:

The stipe will resemble an actual stipe of a kelp (algal) plant. The material will be made of a type of rubber/resin that is now manufactured for aquarium exhibits. The diameter and height of the stipe can be varied, depending on the depth of the aquarium and the amount of feeding that will take place. At the top of the stipe there will be several fronds/branches (depending on need) extending from the stipe that will be the location where the seaweed (algae) pieces will be attached. At the base of each frond there will be a float to thoroughly replicate the seaweed's structure. The attachment section will be comprised of several long clips that are slender, the desired color and inside the branches. The clips will resemble the veins of the kelp blades.

Retrieval and Placement within Aquarium:

The process by which the Kelp Klip will be removed and placed back into the aquarium is by utilizing magnets and a grasping device located at the end of a pole with a handle and a trigger that can be adjusted to fit any average depth of aquarium.

The pole will have the magnet at the end with the grip behind it. The magnet can be used to remove the Kelp Klip from the aquarium and the grip can be used to hold the Kelp Klip before lowering into the aquarium and be easily placed where desired. The grip can also be used to move various items around in the aquarium without getting hands/arms wet. The grip can be used to target feed other invertebrates in the aquarium such as sea anemones and small animals within rock crevasses.

Other Attributes:

The stipe can be changed to other species and colors, (green, red, brown) by removing from peg and replacing with newly desired stipe. Not as unsightly as other clips that have to be attached to the glass/acrylic of the aquarium. Prevents unnecessary scratches to glass and acrylic aquariums. Looks completely natural in an aquarium environment. Salt-water aquarium environments are somewhat expensive. The tropical fish are also somewhat expensive. This product will compliment and add integrity to these environments.

Process of Making the Kelp Klip:

1) The Kelp Klip can be constructed of a resin or plastic material that is currently used to make artificial aquarium plants. The portion of the product that will resemble a rock can be made of a higher-weight resin or plastic, to keep it from being moved by water currents. The magnet that will be used to retrieve the Kelp Klip will be inserted into the plastic or resin that will form the rock structure before it settles, allowing the magnet to be located within the rock without being seen. On the outside of the rock structure, a prong will be molded to allow for the Kelp Klip to be placed within aquaria by the pole that will also be made of a plastic and have a magnet and a grasping device on the end. The feeding devices can also be made of a plastic or resin and molded into the desired shapes. Within these branches of the Kelp Klip (pieces of plastic or resin), the clips (two prongs with a spring at the bottom) will be inserted into the plastic or resin before it has settled. The prongs will also be coated with a protective plastic before insertion into the feeding device (Stipes). The connectors between each stipe and also between the lowest stipe and the rock can be made by creating the appropriate indention that would allow for attachment by the stipes. Each stipe will also have a plug molded at the base that will snap into each indention (hole).

### SEVERAL VIEWS OF THE DRAWINGS OF THE KELP KLIP INVENTION

FIG. 1

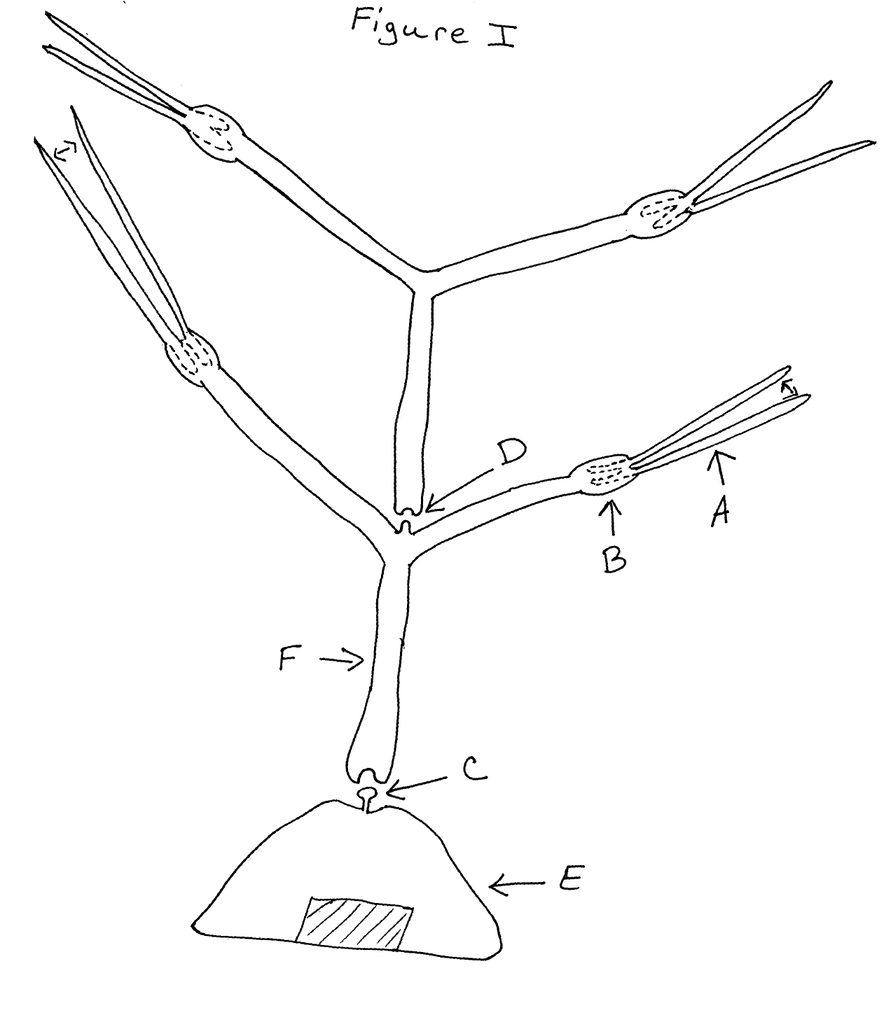

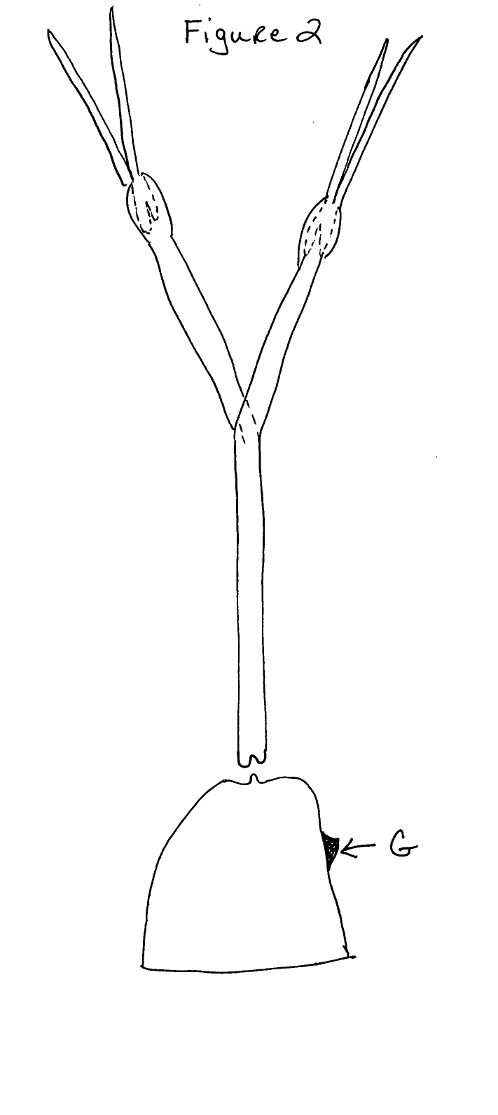

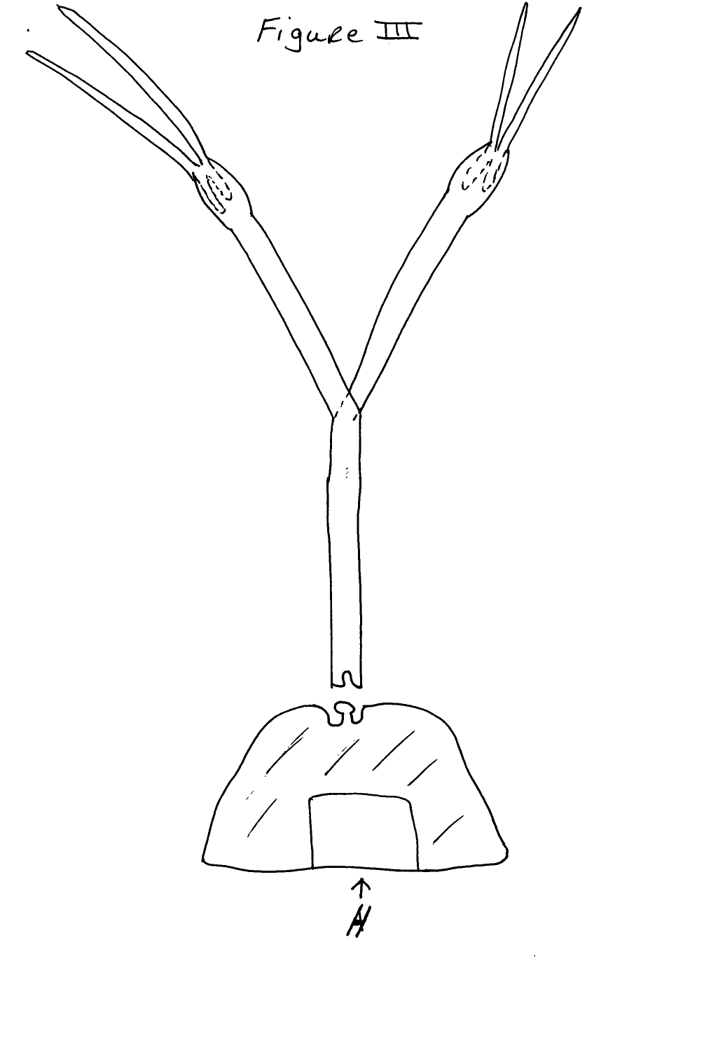

When viewing the kelp klip from the front (Figure I), the product looks like a normal reef rock that has a marine alga attached by a holdfast with the stipe and bladder resembling the thallus of a kelp plant. The grasping prongs (labeled a) protrude directly from the air bladder (labeled b), which is where the seaweed will be held by this mechanism. This section of the mechanism (labeled c) can be attached and removed from the base (labeled e). The base of this mechanism is heavy enough to prevent the mechanism from being moved by water current or fish, and will prevent the mechanism from floating to the surface of the water. Additional feeding sections (labeled d) can be attached when feeding large numbers of fish. The section of the mechanism (labeled f) is constructed of a sturdy resin or plastic material that will be strong enough to keep the entire feeding mechanism upright in the water.

FIG. 2

When viewing the kelp klip from the right side (Figure II), the base resembles a reef rock with a marine algae attached. The small prong (labeled g) is visible from this side to reveal where the device can be grabbed to be placed in the desired location within the aquarium.

FIG. 3

When viewing the kelp klip from the left side (Figure III), there is a solid, smooth area at the base of the mechanism that allows for easy identification of the areas that contains the magnet. This will allow for easy retrieval of the kelp klip from an aquarium.

What is claimed is:

1. The Kelp Klip does not resemble any current type of device used to place algae inside of, or feed fish in an aquarium.

2. This invention will make the feeding of fish and other animals easier than any other products currently available that feed fish in aquariums.

3. This invention will prevent the individual from getting clothes and arms wet during the feeding process.

4. Due to the design of this invention, it will minimize the amount of wasted seaweed into the aquarium.

5. This invention will not be as noticeable as other products that are used to feed fish in aquariums.
